(19) United States
(12) Patent Application Publication
(10) Pub. No.: US 2014/0164391 A1
(43) Pub. Date: Jun. 12, 2014

(54) DATA BLOCK SAVING SYSTEM AND METHOD

(71) Applicants: HON HAI PRECISION INDUSTRY CO., LTD., New Taipei (TW); HONG FU JIN PRECISION INDUSTRY (ShenZhen) CO., LTD ., Shenzhen (CN)

(72) Inventors: ZHI-QUAN CHAI, Shenzhen (CN); DA-PENG LI, Shenzhen (CN); HAI-HONG LIN, Shenzhen (CN); CHUNG-I LEE, New Taipei (TW)

(73) Assignees: HON HAI PRECISION INDUSTRY CO., LTD., New Taipei (TW); HONG FU JIN PRECISION INDUSTRY (ShenZhen) CO., LTD ., Shenzhen (CN)

(21) Appl. No.: 14/065,483

(22) Filed: Oct. 29, 2013

(30) Foreign Application Priority Data
Dec. 12, 2012 (CN) 201210534098X

(51) Int. Cl. G06F 17/30

(52) U.S. Cl. CPC G06F 17/30097
USPC 707/747

(57) ABSTRACT

An assignment server receives a data block of the file from a client. The assignment server determines if the obtained data block is a repetitive data block. The assignment server uploads the obtains data block from the client into a storage server when the obtained data block is not the repetitive data block.

### BACKGROUND

1. Technical Field

The embodiments of the present disclosure relate to management technology, and particularly to a data block saving system and method.

2. Description of Related Art

A data center is a facility which houses a large number of computers and stores huge amounts of data. By using cloud computing, the files are uploaded into a data center. However, at present, a file stored in the data center may include duplicates or duplicated portions, which waste a lot of storage spaces. Therefore, there is room for improvement in the art.

### BRIEF DESCRIPTION OF THE DRAWINGS

FIG. 1 is a block view of one embodiment of an assignment server including a data block saving system.

FIG. 2 is a block diagram of one embodiment of function modules of the data block saving system in FIG. 1.

FIG. 3 is a flowchart of one embodiment of a data block saving method.

FIG. 4 illustrates one embodiment of uploading two or more data blocks from different clients into a storage server.

FIG. 5 is a flowchart of one embodiment of downloading a file from the storage server.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

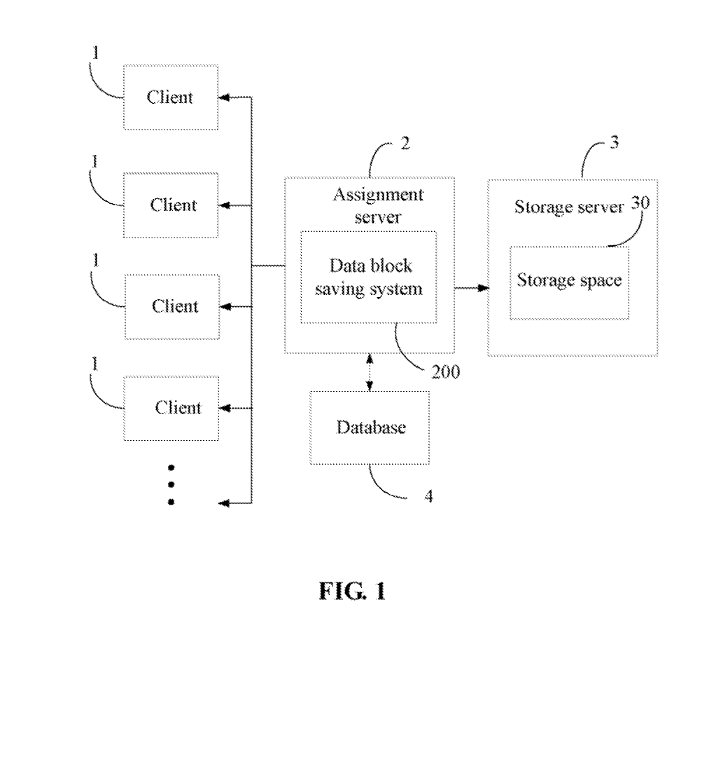

FIG. 1 is a block diagram of one embodiment of an assignment server 2. In this embodiment, the server 2 includes a data block saving system 100. The assignment server 2 connects to one or more clients 1 via a network (e.g., the Internet or a local area network). Each client 1 may provide a user interface, which is displayed on a display device of the client 1, for a user to access the assignment server 2 and control one or more operations of the assignment server 2. The user may input an ID and a password using an input device (e.g., a keyboard) into the user interface to access the assignment server 2. The client 1 may be, but is not limited to, a mobile phone, a tablet computer, a personal computer or other data-processing apparatus. The assignment server 2 connects to a storage server 3 via the network. The assignment server 2 connects to a database 4 using a data connectivity, such as open database connectivity (ODBC) or JAVA database connectivity (JDBC), for example. The storage server 3 stores files uploaded from the client 3 through the assignment server 2. In other words, the client 1 uploads the files into the assignment server 2, and the assignment server 2 sends the received files from the client 1 to the storage servers 3. The storage server 3 also includes one or more storage spaces 30, the data blocks of each file are stored into different storage spaces 30.

In one embodiment, the client 1 divides each file into two or more data blocks, and uploads the two or more data blocks of the file into the assignment server 2. The assignment server 2 sends the two or more data blocks of the file to the storage server 3. Additionally, before uploading the two or more data blocks of the file into the assignment server 2, the client 1 further calculates a hash value of each data block and saves the hash value of each data block into a hash list. The client 1 also includes information of the files. The information of each file includes a name of the file and an attribute of the file. Furthermore, each file corresponds to a hash list. In other words, the data blocks of the file are saved into the hash list corresponding to the file. Each data block includes a name. The name of each data block is generated in order and also saved into the hash list. In detail, the name of each data block is generated in an alphabetical order (e.g., “a,” “b,” “c,” “d,” “d,” or “f”) or in a numerical order (e.g., “1,” “2,” “3,” or “4”). For example, the file is divided to three data blocks, namely data block “a,” data block “b,” and data block “c.” Each data block may include a storage capacity predetermined by a user, such as 16 KB, 32 KB, 64 KB, 128 KB, or 256 KB. For example, if the storage capacity is predetermined as 32 KB, the file is divided into a plurality of data blocks, and each data block is 32 KB.

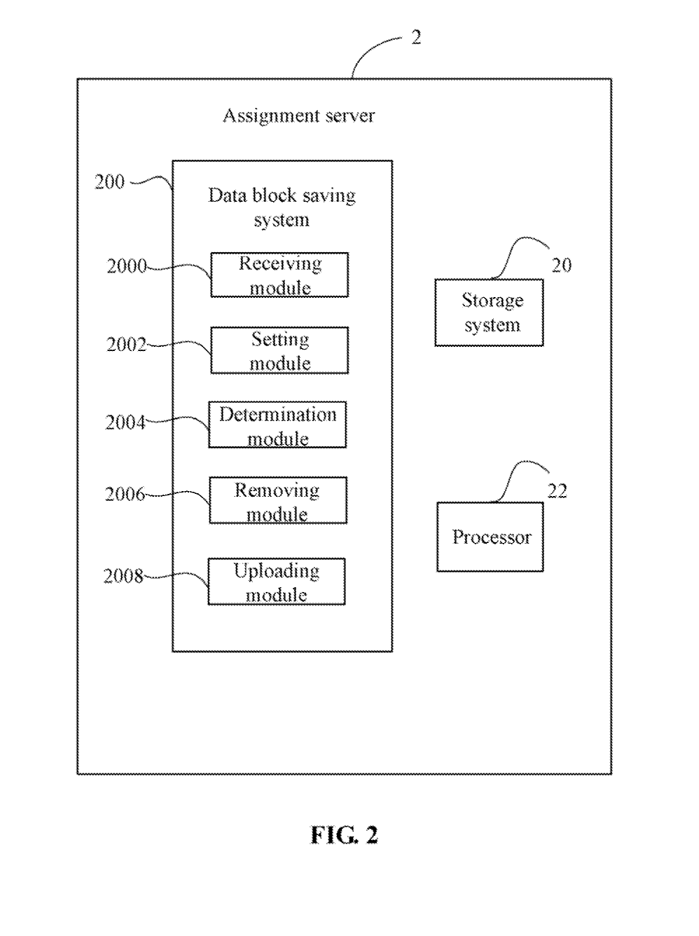

FIG. 2 is a block diagram of one embodiment of the data block saving system 200 included in the server 2 of FIG. 1. The data block saving system 200 processes a file and uploads the processed file into a storage server 3. In one embodiment, the assignment 2 further includes a storage system 20 and at least one processor 22. The data block saving system 200 includes a receiving module 2000, a setting module 2002, a determination module 2004, a removing module 2006, and an uploading module 2008. The modules 2000-2008 may include computerized code in the form of one or more programs that are stored in the storage system 20. The computerized code includes instructions that are executed by the at least one processor 22 to provide functions for the modules 2000-2008. The storage system 20 may be a memory, such as an EPROM memory chip, hard disk drive (HDD), or flash memory stick.

The receiving module 2000 receives a hash list corresponding to a file and information of the file uploaded from the client 1, and saves the hash list corresponding to the file and information of the file into the database 4. For example, the receiving module 2000 receives the hash list corresponding to the file A and information of the file A from the client A1, the receiving module 2000 receives the hash list corresponding to the file B and information of the file A from the client B1, and the receiving module 2000 receives the hash list corresponding to the file B and information of the file B from the client B1.

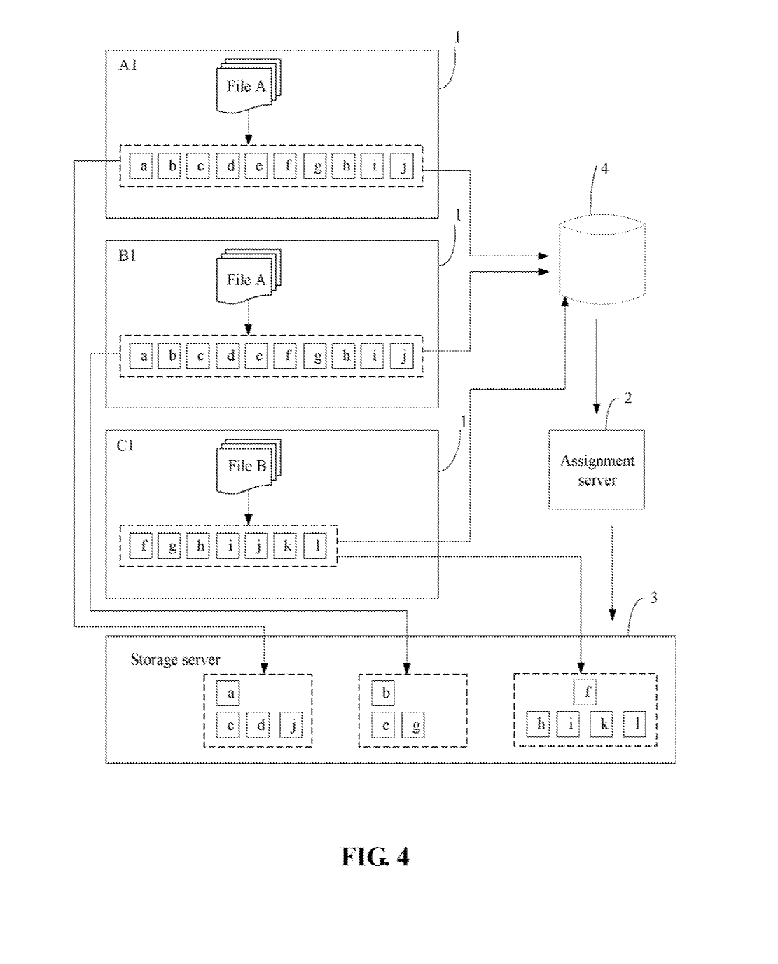

The setting module 2002 sets a sequence number of each data block. In one embodiment, the sequence number of each data block may be in the alphabetical order (e.g., “a,” “b,” “c,” “d,” “d,” or “f”) or in the numerical order (e.g., “1,” “2,” “3,” or “4”). As shown in FIG. 4, the setting module 2002 sets a sequence number of each data block of the file A stored in the client A1, the setting module 2002 sets a sequence number of each data block of the file A stored in the client B1, and the setting module 2002 sets a sequence number of each data block of the file B stored in the client C1.

The determination module 2004 obtains a data block according to the sequence number of the data block and determines if the obtained data block is a repetitive data block. For example, the determination module 2004 obtains the data blocks of the file A stored in the client A1 in the alphabetical order, for example, from the data block “a” to the data block “f”). The determination module 2004 searches for repetitive data blocks according to the hash value of each data block.

The obtained data block is determined as the repetitive data block upon the condition that the hash values of the obtained data block is the same as the hash values of other data blocks in the storage server 3. For example, as shown in FIG. 4, both the client A1 and client B1 include the data block “a,” and the data base 4 includes two hash values of the data block “a.” When the storage server 3 have already included the data block “a,” then the obtained data block “a” from the client A1 is determined as repetitive blocks.

The obtained data block is further determined as the repetitive data block upon the condition that the hash values of the obtained data block is the same as the hash values of other data blocks which is in a process of uploading into the storage server 3. In one embodiment, for example, as shown in FIG. 4, both the client A1 and client B1 include the data block “a,” and the data base 4 includes two hash values of the data block “a.” When the data block “a” from the client B1 is in a process of uploading, then the obtained data block “a” from the client A1 is determined as the repetitive block.

The removing module 2006 skips the obtained data block and obtains next data block according to the sequence number of each data block. For example, if the obtained data block “a” from the client A1 is determined as the repetitive data block, the removing module 2006 skips the obtained data block “a,” and obtains next data block “b.”

The uploading module 2008 uploads the obtained data block from the client 1 into the storage server 3. Additionally, the uploading module 2008 sends a pointer of the obtained data block to the client 1. The pointer of the obtained data block is received from the assignment server 2 and displayed on a display device of the client 1. The obtained data block corresponds to a pointer that points to a storage space of the storage server 3. In other words, a user uses the pointer to find the storage space and know where the obtained data block is saved in the storage server 3. The storage space may store one or more data blocks in the server 2. Furthermore, even the repetitive data blocks are skipped in the client 1, however, each repetitive data block is also assigned to one pointer, and the pointer corresponding to the repetitive data block is the same as the pointer corresponding to the data block in the storage server 3.

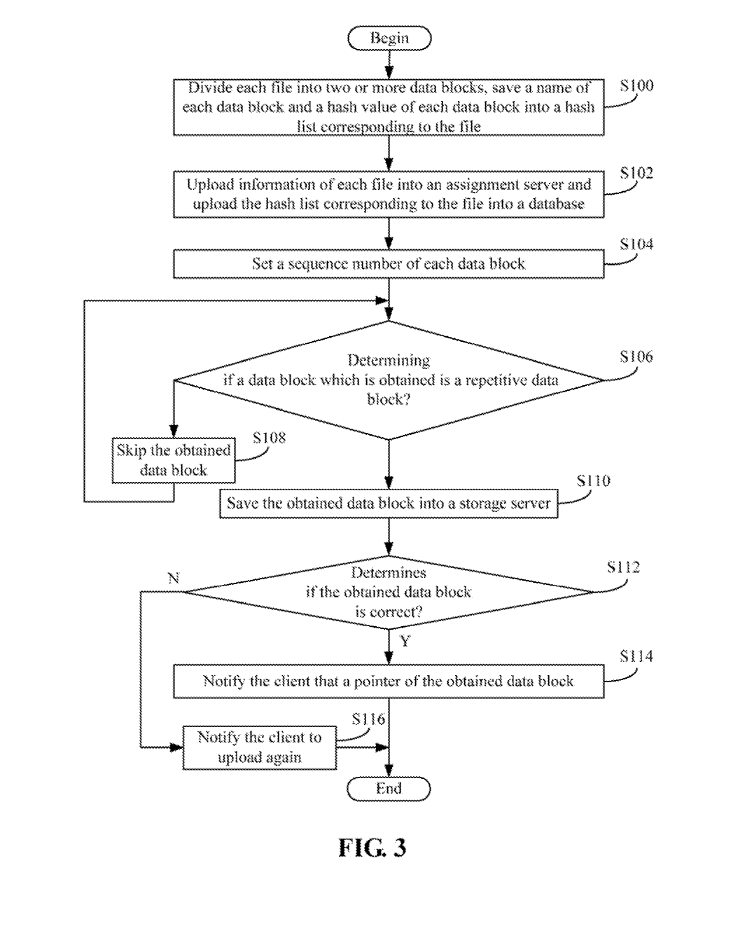

FIG. 3 is a flowchart of one embodiment of a data block saving method. Depending on the embodiment, additional steps may be added, others deleted, and the ordering of the steps may be changed.

In step S100, each client 1 divides a file stored in the client 1 into two or more data blocks, saves a name of each data block and a hash value of each data block into a hash list. For example, as shown in FIG. 4, the client A1 divides the file A into ten data blocks, namely the data block “a,” the data block “b,” the data block “c,” the data block “d,” the data block “e,” the data block “f,” the data block “g,” the data block “h,” the data block “i,” and the data block “j.” The client B1 divides the file A into ten data blocks, namely the data block “a,” the data block “b,” the data block “c,” the data block “d,” the data block “e,” the data block “f,” the data block “g,” the data block “h,” the data block “i,” and the data block “j.” The client C1 divides the file B into ten data blocks, namely the data block “f,” the data block “g,” the data block “h,” the data block “i,” the data block “j,” the data block “k,” and the data block “l.”

In step S102, each client 1 uploads information of the file into an assignment server 2 and uploads the hash list corresponding to the file into a database 4. The receiving module 2000 receives the information of the file and the hash list from each client 1.

In step S104, the setting module 2002 sets a sequence number of each data block. As shown in FIG. 4, the setting module 2002 sets a sequence number of each data block of the file A stored in the client A1, the setting module 2002 sets a sequence number of each data block of the file A stored in the client B1, and the setting module 2002 sets a sequence number of each data block of the file B stored in the client C1.

In step S106, the determination module 2004 obtains a data block according to the sequence number of the data block and determines if the obtained data block is a repetitive data block. In one embodiment, the determination module 2004 searches for repetitive data blocks according to the hash value of each data block. If the obtained data block is the repetitive data block, the procedure goes to step S108. Otherwise, if the obtained data block is not the repetitive data block, the procedure goes to step S110.

In step S108, the removing module 2006 skips the obtained data block and obtains next data block according to the sequence number of each data block, then the procedure returns to step S106.

In step S110, the uploading module 2008 uploads the obtained data block from the client 1 into the storage server 3. The uploading module 2008 also obtains a pointer of the obtained data block when the obtained data block is saved into the storage server 3, and the uploading module 2008 sends the pointer of the obtained data block to the client 1.

In step S112, the available server 3 receives the obtained data block from the assignment server 2, and determines if the obtained data block is correct. In one embodiment, when the storage server 3 receives the obtained data block from the assignment server 2, the storage server 3 also calculates the hash value of the obtained data block, and verifies if the hash value of the obtained data block exists in the hash list. If the hash value of the obtained data block exists in the hash list, the data block is determined to be correct, the procedure goes to step S114. If the hash value of the obtained data block does not exist in the hash list, the obtained data block is determined to not be correct, the procedure goes to step S116.

In step S114, the storage server 3 sends the pointer of the obtained data block to the client 1.

In step S116, the storage server 3 notifies the client 1 to upload the obtained file again.

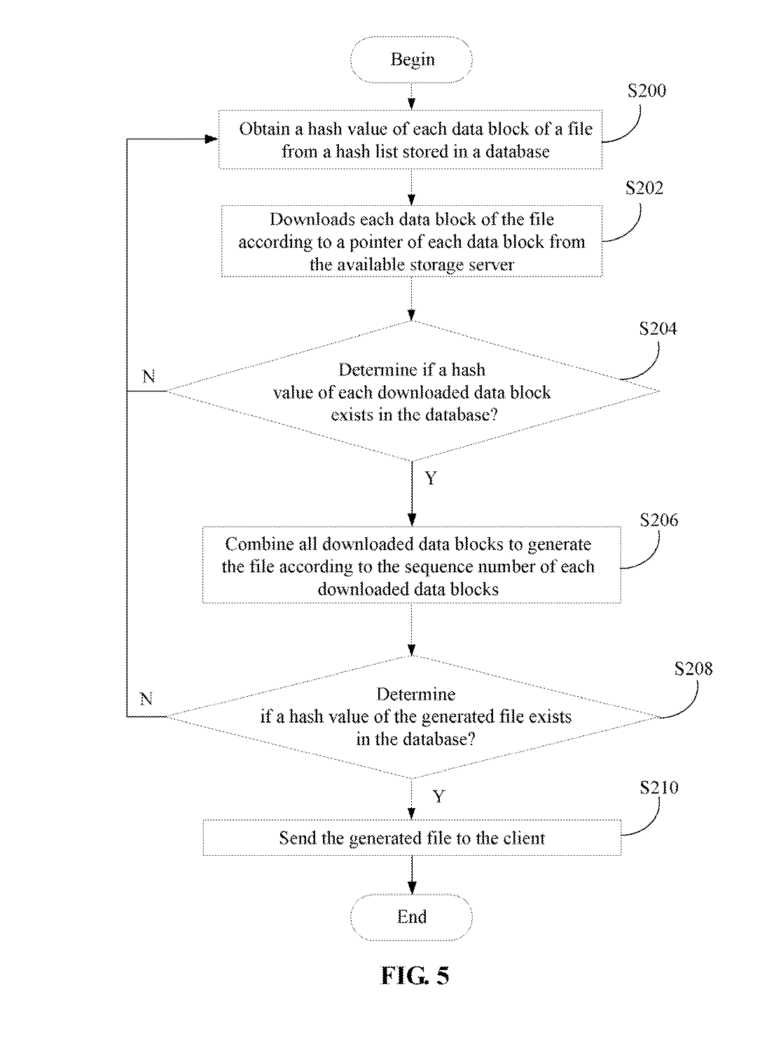

FIG. 5 is a flowchart of one embodiment of downloading a file from a storage server.

In step S200, the client 1 obtains a hash value of each data block of a file from a hash list stored in a database 4.

In step S202, the client 1 downloads each data block of the file according to a pointer of each data block from the storage server.

In step S204, the download module 2012 calculates a hash value of each downloaded data block and determines if the hash value of each downloaded data block exists in the hash list stored in the database 4. In one embodiment, if the calculated hash value of each downloaded data block exists in the database 4, the procedure goes to step S206. Otherwise, if one calculated hash value of the downloaded data block does not exist in the hash list, the procedure returns to step S200.

In step S206, the client 1 combines all downloaded data blocks to generate the file in the temporary storage space of the client 1 according to the sequence number of each downloaded data block. The temporary storage space of the client 1 may be, but is not limited to, a random access memory (RAM). In one embodiment, the sequence number of each downloaded data block is generated in order, and the client 1 combines all downloaded data blocks to generate the file in order of the sequence number of each downloaded data block.

In step S208, the client 1 calculates the hash value of the generated file and determines if the calculated hash value of the generated file exists in the hash list stored in the database 4. If the calculated hash value of the generated file exists in the hash list, the procedure goes to step S210. If the calculated hash value of the generated file does not exists in the hash list, the client 1 displays fail information (e.g., display “FAIL”) on the display device of the client 1, and the procedure returns to step S200.

In step S210, the client 1 displays the generated file and success information (e.g., display “SUCCESS”) on a display device of the client 1

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An assignment server in electronic communication with a plurality of clients and a storage server, comprising:
at least one processor; and
a storage system that stores one or more programs, when executed by the at least one processor, cause the at least one processor to perform a data block saving method, the method comprising:
receiving a hash list corresponding to a file from the client, and saving the hash list corresponding to the file into a database connected to the assignment server, wherein the hash list comprises a hash value of each data block of the file;
calculating a transfer process usage ratio of each storage server and a remaining storage capacity of each storage server;
setting a sequence number of each data block;
obtaining a data block according to the sequence number of the data block and determining if the obtained data block is a repetitive data block;
skipping the obtained data block and obtains next data block according to the sequence number of each data block when the obtained data block is a repetitive data block; and
uploading the obtained data block from the client into the storage server when the obtained data block is not a repetitive data block.

2. The assignment server of claim 1, wherein a method of dividing the file by the client comprises:
the client divides each file into two or more data blocks;
the client calculates the hash value of each data block; and
the client saves the hash value of each data block into the hash list.

3. The assignment server of claim 1, wherein the sequence number of each data block is generated in an alphabetical order or in a numerical order.

4. The assignment server of claim 1, wherein the obtained data block is determined as a repetitive data block upon the condition that the hash values of the obtained data block is the same as the hash values of other data blocks in the storage server.

5. The assignment server of claim 1, wherein the obtained data block is determined as a repetitive data block upon the condition that the hash values of the obtained data block is the same as the hash values of other data blocks which is in a process of uploading into the storage server.

6. The assignment server of claim 1, wherein a method of saving the obtained data block into the storage sever comprises:
the storage sever calculates the hash value of the obtained data block uploaded from the assignment server;
the storage sever determines whether the hash value of the obtained data block exists in the hash list; and
the storage sever notifies the client to upload the obtained data block again when the hash value of the obtained data block does not exists in the hash list.

7. The assignment server of claim 1, wherein a method of downloading the file from the storage server comprises:
the client obtains the hash value of each data block of the file from the hash list stored in the database;
the client downloads each data block of the file according to a pointer of each data block from the storage server;
the client calculates a hash value of each downloaded data block, and determines if the hash value of each downloaded data block exists in the hash list stored in the database;
the client combines all downloaded data blocks to generate the file in the client according to the sequence number of each downloaded data block, when the hash value of each downloaded data block exists in the hash list stored in the database;
the client calculates the hash value of the generated file and determines if the calculated hash value of the generated file exists in the hash list stored in the database; and
the client displays the generated file when the calculated hash value of the generated file exists in the hash list stored in the database.

8. A data block saving method implemented by an assignment server, the assignment server in electronic communication with a plurality of clients and a storage server, the method comprising:
receiving a hash list corresponding to a file from the client, and saving the hash list corresponding to the file into a database connected to the assignment server, wherein the hash list comprises a hash value of each data block of the file, and a name of each data block;
calculating a transfer process usage ratio of each storage server and a remaining storage capacity of each storage server;
setting a sequence number of each data block;
obtaining a data block according to the sequence number of the data block and determining if the obtained data block is a repetitive data block;
skipping the obtained data block and obtains next data block according to the sequence number of each data block when the obtained data block is a repetitive data block; and
uploading the obtained data block from the client into the storage server when the obtained data block is not a repetitive data block.

9. The method of claim 8, wherein a method of dividing the file by the client comprises:
the client divides each file into two or more data blocks;
the client calculates the hash value of each data block; and
the client saves the hash value of each data block into the hash list.

10. The method of claim 8, wherein the sequence number of each data block is generated in an alphabetical order or in a numerical order.

11. The method of claim 8, wherein the obtained data block is determined as a repetitive data block upon the condition that the hash values of the obtained data block is the same as the hash values of other data blocks in the storage server.

12. The method of claim 8, wherein the obtained data block is determined as a repetitive data block upon the condition that the hash values of the obtained data block is the same as the hash values of other data blocks which is in a process of uploading into the storage server.

13. The method of claim 8, wherein a method of saving the obtained data block into the available storage sever comprises:
the storage sever calculates the hash value of the obtained data block uploaded from the assignment server;
the storage sever determines whether the hash value of the obtained data block exists in the hash list; and
the storage sever notifies the client to upload the obtained data block again when the hash value of the obtained data block does not exists in the hash list.

14. The method of claim 8, wherein a method of downloading the file from the storage server comprises:
the client obtains the hash value of each data block of the file from the hash list stored in the database;
the client downloads each data block of the file according to a pointer of each data block from the storage server;
the client calculates a hash value of each downloaded data block, and determines if the hash value of each downloaded data block exists in the hash list stored in the database;
the client combines all downloaded data blocks to generate the file in the client according to the sequence number of each downloaded data block, when the hash value of each downloaded data block exists in the hash list stored in the database;
the client calculates the hash value of the generated file and determines if the calculated hash value of the generated file exists in the hash list stored in the database; and
the client displays the generated file when the calculated hash value of the generated file exists in the hash list stored in the database.

15. A non-transitory computer-readable medium having stored thereon instructions that, when executed by an assignment server, the assignment server in electronic communication with a plurality of clients and a storage server, causing the assignment server to perform a data block saving method, the method comprising:
receiving a hash list corresponding to a file from the client, and saving the hash list corresponding to the file into a database connected to the assignment server, wherein the hash list comprises a hash value of each data block of the file, and a name of each data block;
calculating a transfer process usage ratio of each storage server and a remaining storage capacity of each storage server;
setting a sequence number of each data block;
obtaining a data block according to the sequence number of the data block and determining if the obtained data block is a repetitive data block;
skipping the obtained data block and obtains next data block according to the sequence number of each data block; and
uploading the obtained data block from the client into the storage server when the obtained data block is not the repetitive data block.

16. The non-transitory computer-readable medium of claim 15, wherein a method of dividing the file by the client comprises:
the client divides each file into two or more data blocks;
the client calculates the hash value of each data block; and
the client saves the hash value of each data block into the hash list.

17. The non-transitory computer-readable medium of claim 15, wherein the obtained data block is determined as a repetitive data block upon the condition that the hash values of the obtained data block is the same as the hash values of other data blocks in the storage server.

18. The non-transitory computer-readable medium of claim 15, wherein the obtained data block is determined as a repetitive data block upon the condition that the hash values of the obtained data block is the same as the hash values of other data blocks which is in a process of uploading into the storage server.

19. The non-transitory computer-readable medium of claim 15, wherein a method of saving the obtained data block into the available storage sever comprises:
the storage sever calculates the hash value of the obtained data block uploaded from the assignment server;
the storage sever determines whether the hash value of the obtained data block exists in the hash list; and
the storage sever notifies the client to upload the obtained data block again when the hash value of the obtained data block does not exists in the hash list.

20. The non-transitory computer-readable medium of claim 15, wherein a method of saving the obtained data block into the available storage sever comprises:
wherein a method of downloading the file from the storage server comprises:
the client obtains the hash value of each data block of the file from the hash list stored in the database;
the client downloads each data block of the file according to a pointer of each data block from the storage server;
the client calculates a hash value of each downloaded data block, and determines if the hash value of each downloaded data block exists in the hash list stored in the database;
the client combines all downloaded data blocks to generate the file in the client according to the sequence number of each downloaded data block, when the hash value of each downloaded data block exists in the hash list stored in the database;
the client calculates the hash value of the generated file and determines if the calculated hash value of the generated file exists in the hash list stored in the database; and
the client displays the generated file when the calculated hash value of the generated file exists in the hash list stored in the database.
